(19) United States
(12) Patent Application Publication
(10) Pub. No.: US 2022/0014593 A1
(43) Pub. Date: Jan. 13, 2022

(54) DISCOVERY OF INTERNET-OF-THINGS RESOURCES

(71) Applicant: Orange, Paris (FR)

(72) Inventors: Si Wu, Beijing (CN); Zhihong Guo, Beijing (CN)

(21) Appl. No.: 17/280,814

(22) PCT Filed: Sep. 30, 2019
(86) PCT No.: PCT/IB2019/001163

§ 371 Date: Mar. 26, 2021

(30) Foreign Application Priority Data
Sep. 29, 2018 (CN) PCT/CN2018/108840

(51) Int. Cl. H04L 29/08; G06F 3/16

(52) U.S. Cl. CPC H04L 67/16; G06F 3/16; H04L 67/36; H04L 67/12

(57) ABSTRACT

A discovery system to discover Internet of Things (IoT) resources for a user includes a user client and a server apparatus. The server apparatus determines the user context and establishes a user requirement specification based on the user context and, if provided, on user requirements articulated by the user via the user client. The server apparatus identifies one or more categories of IoT object that match the user requirement specification and interrogates an IoT-object platform to identify IoT resources that correspond to the identified categories. The server apparatus sends the user client information identifying the IoT resource(s) identified by the IoT-object-platform interface. The disclosure also describes a corresponding discovery method, a server apparatus, a method implemented by the server apparatus, a computer program for execution to implement the user client and a computer-implemented method for implementation in a user device to implement the user client.

The present invention relates to the field of the Internet of Things (IoT). More particularly, the invention relates to systems and methods providing discovery of IoT resources.

Incidentally, in this document the expression “IoT resources” refers to IoT objects and to services provided by IoT objects. Moreover, the expression “IoT object” refers to connected IoT devices (e.g. a connected beverage machine, a connected air conditioning unit, etc.) as well as to unconnected objects (e.g. a swimming pool, a printing shop, etc.), and “connected” refers to the object in question having a connection to a communications network (e.g. telecommunications network, computer network, LAN, WAN, short-range connection technology such as Bluetooth, etc.)

The Internet of Things is becoming progressively better established, and increasing numbers of IoT devices are being brought into operation. To facilitate the development of the Internet of Things, it becomes important to provide mechanisms to enable IoT resources to be discovered automatically. For instance, IoT devices may need to discover other IoT resources in order to be able to collaborate in performance of some service. As another example, a user may not know what IoT resources are available to them at a particular moment and, because of this ignorance, may fail to make use of an IoT resource which was available.

One approach would be to provide mechanisms to inform a user device (e.g. a mobile terminal) of all the IoT resources that are present in the user's environment at a given time so that the user may be alerted to the existence of those resources, e.g. by display on the user device of an exhaustive list of IoT objects and services. However, in an environment that is well-populated with IoT resources this can lead to a user being presented with a long list of IoT resources and the user needs to expend time and effort in examining the different available resources and finding out how to access a selected resource.

Request-based systems have been proposed to enable a search to be made, by devices or by human users, for IoT resources of specified type. For example, systems have been proposed to recommend IoT devices by matching the semantic similarity between a device service description and a search request, in which the device service description is exposed by Service Oriented Architecture (SOA). One such proposal is described in “Efficient semantic-based IoT service discovery mechanism for dynamic environments” by Sameh Ben Fredj, Mathieu Boussard, Daniel Kofman, and Ludovic Noirie (IEEE 25th Annual International Symposium on Personal, Indoor, and Mobile Radio Communication (PIMRC), 2014, September 2014, Washington, United States. pp. 2088-2092, 2014). Another proposal in this regard, “Semantic-based IoT device discovery and recommendation mechanism” by Stefana Chirila, Camelia Lemnaru and Mihaela Dinsoreanu (IEEE ICCP 2016), describes a broker-based architecture to recommend devices by semantically matching web service discovery and a requester's requirements.

The above-mentioned publications describe techniques for finding semantically-matched IoT devices but, in the case where the requester looking for IoT resources is a human user, they place a high burden on the user to articulate their requirements, notably using programming language.

Moreover, in the prior proposals, device discovery is based on the premise that each device exposes its function or service using the SOAP or WSDL protocols. However, because of the diversity in different IoT devices and their manufacturers, in the real world this criterion is not always satisfied.

The present invention has been made in the light of these issues.

Embodiments of the present invention provide a discovery system to discover Internet of Things (further referred to as IoT) resources for a user, the system comprising:

a user client implemented in a user device, the user client comprising:
a reception unit to receive information identifying IoT resources adapted to satisfy user requirements; and

server apparatus comprising:
a user-context determination unit to determine the user context,
a user-requirement assessment unit to determine a user requirement specification based on the user context determined by the user-context determination unit,
   a category identification unit to identify one or more categories of IoT object that match the user requirement specification,
   an IoT-object-platform interface to interrogate an IoT-object platform, to identify IoT resource(s) that correspond to the identified one or more categories of IoT object, and
   an output unit to send, to the user client, information identifying the IoT resource(s) identified by the IoT-object-platform interface.

Embodiments of the invention further provide a corresponding computer-implemented method to discover IoT resources for a user.

Embodiments of the invention yet further provide a server apparatus and a user device, as specified respectively in appended claims 11 and 12.

Embodiments of the invention still further provide a corresponding computer-implemented method performed by a server apparatus, as specified in appended claim 13. In a specific embodiment of such a method, the method also comprises receiving, from the user client, information representative of user input, the information being indicative of a user requirement; wherein the determining of a user requirement specification is based on the determined user context and based on information, received from the user client, indicative of a user requirement.

Embodiments of the invention still further provide a computer program comprising instructions for execution by a processor of a user device to implement a user client, as specified in appended claim 14. In a specific embodiment of such a computer program, these instructions, when executed by a processor of a user device, cause the user device to implement a user client performing a method further comprising interrogating IoT devices local to the user device to determine at least one item of information descriptive of the user context and outputting to the server apparatus information, received from interrogated IoT devices, descriptive of the user context.

Embodiments of the invention still further provide a computer-implemented method, performed by a user client on a user device, as specified in appended claim 15. In a specific embodiment of such a computer-implemented method, the method further comprising interrogating IoT devices local to the user device to determine at least one item of information descriptive of the user context and outputting to the server apparatus information, received from interrogated IoT devices, descriptive of the user context.

The above-mentioned discovery system, discovery method, server apparatus, method implemented by server apparatus, computer program and method implemented by a user client reduce the burden on a user who wishes to discover IoT resources that meet their requirements. The user is provided with a user-friendly, intelligent and targeted discovery technique which is able to determine user requirements from the user context as well as from explicit user input (when the latter is provided).

The proposed technique may determine inferred as well as articulated user requirements based on the user's intention and the user context, wherein the user's intention is deduced by analyzing user input (e.g. in text or voice), if any. User context may be analyzed via multiple sources to infer additional requirements (including “requirements” which represent opportunities to provide the user with a function or service matching their context). This approach may deduce what kind of device/IoT resource the user wants based on previous analyzing results, may find out corresponding IoT objects from an IoT-object platform, and finally returns data identifying these objects to the user.

Unlike previous solutions, which focused on finding IoT devices' service semantically matched to explicit statements of requirements, embodiments of the invention identify IoT objects for a user according to user's explicit and inferred requirements, which are obtained by analyzing the user's explicit intention (from user input) and inferred potential user requirements (considering user contexts).

The user client may further comprise a client-side user-context identification unit to output, to the server apparatus, information indicative of at least one aspect of the user context. This context information provided from the user client side may include information stored or generated by the user device per se and/or information obtained by interrogating IoT devices local to the user device.

In the case where user-context information is obtained directly from the user client, the processing and communication burden on the server apparatus may be reduced.

The user client may be configured to notify the server apparatus of IoT devices local to the user device and the user-context determination unit of the server apparatus may be configured to interrogate an IoT-object platform to retrieve user-context information generated by one or more of the IoT devices identified in the notification. In this case user-context information can be obtained by the server apparatus even in a case where the user client is not able to retrieve context data directly from its local IoT devices.

The user-requirement assessment unit of the server apparatus may comprise a natural-language analysis tool to determine user requirements by processing user input expressed in natural language. In this way the user is liberated from the obligation to articulate their requirements using a programming language. Accordingly, the discovery process is made simpler for the user. Also, the discovered IoT resources which are reported to the user are more likely to closely match the user's actual requirements.

The user-requirement assessment unit may comprise various tools to deduce and/or infer user requirements to put in the user-requirement specification, including but not limited to: a natural language processing tool, performing text recognition or semantic entity analysis for instance.

The category identification unit may comprise various tools to identify one or more categories of IoT object that match the user requirement specification, including but not limited to: a cognitive reasoning engine and a collaborative filtering unit.

The IoT-object-platform interface may be configured to interrogate the IoT-object platform using adapted object categories mapped, by a semantic matching unit, from the object categories identified by the category identification unit. In the case where the IoT-object platform-interface has the capability to perform an adaptation of its own object categories to suit object categories used by an IoT-object platform, notably an external IoT-object platform, it is possible to implement the server apparatus as a configurable entity that is capable of being customized to interact with different IoT-object platforms (e.g. platforms established by different service-operators). Moreover, in the case where the IoT-object platform-interface comprises a semantic matching unit the server apparatus may be self-configurable so that it does not need pre-programming based on knowledge of different IoT-object platforms with which it may interact.

In an embodiment of the discovery system, the server apparatus is configured to determine the user requirement specification, interrogate the IoT-object platform and output said information identifying IoT resources to the user client in response to a trigger event, the trigger event being an event in the list consisting of: reception from the user client of information representative of a user input indicative of a user requirement, reception of new or updated user-context data from the user client, from an IoT object, from an IoT-object platform or from an external source, and elapsing of a determined time period.

The output unit may be configured to send, to the user client, not just information identifying the discovered IoT resources which match the user requirement specification, but also access information indicative of how the user device can access the identified IoT resources. In this way the user not only finds out which IoT resources are available to meet their requirements but also is enabled to actually make use of the available resources. Moreover, the output unit may be configured to inform the user client only of IoT resources that are actually available to the user (e.g. excluding private IoT resources), so as to avoid presenting the user with redundant information and so as to reduce the communications overhead of the system.

Further features and advantages of embodiments of the present invention will become apparent from the following description of said embodiments, which is given by way of illustration and not limitation, illustrated by the accompanying drawings, in which:

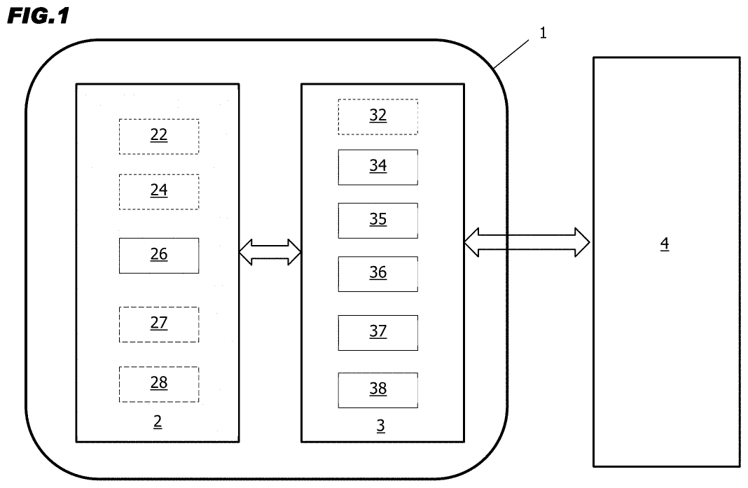

FIG. 1 illustrates an example of an IoT-resource discovery system according to a first embodiment of the invention;

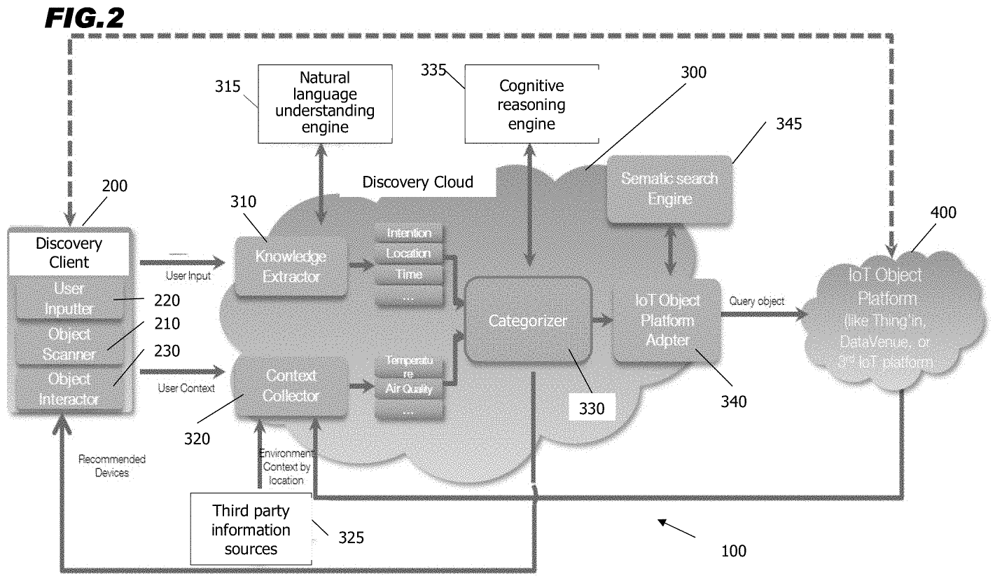

FIG. 2 illustrates an example implementation of the system illustrated in FIG. 1;

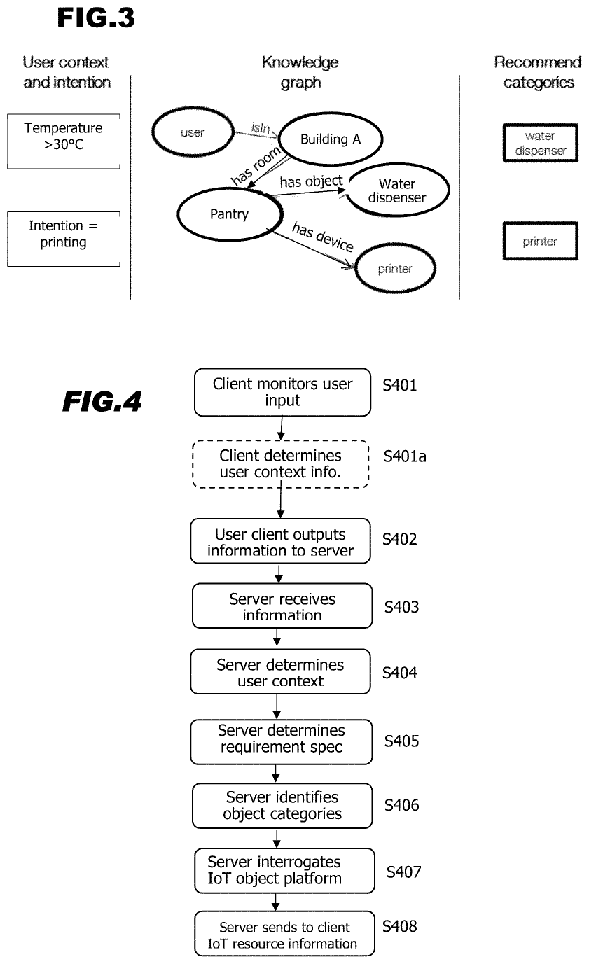

FIG. 3 is a diagram schematically representing a knowledge-graph-based reasoning engine;

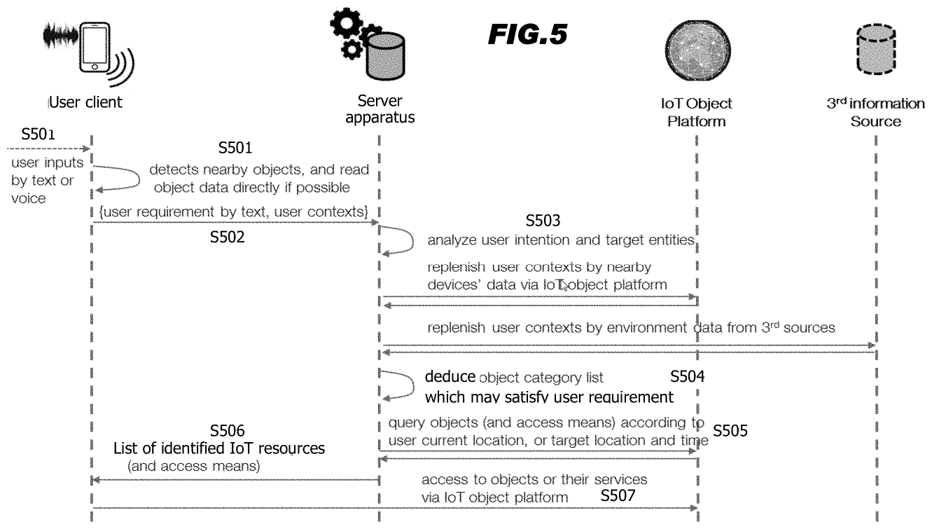

FIG. 4 is a flow diagram illustrating steps in an example of a discovery method, implemented by a system, according to an embodiment of the invention;

FIG. 5 is a diagram illustrating interactions between elements implementing a discovery method according to an embodiment of the invention;

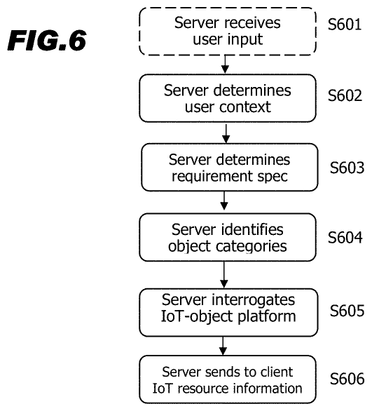

FIG. 6 is a flow diagram illustrating steps in an example of a method according to an embodiment of the invention, implemented by server apparatus; and

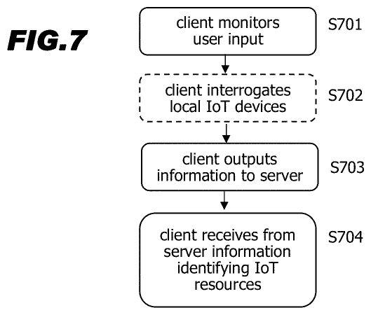

FIG. 7 is a flow diagram illustrating steps in an example of a method according to an embodiment of the invention, implemented by a user client in a user device.

Certain embodiments of the invention will now be described for the purposes of illustration, not limitation.

FIG. 1 illustrates a discovery system 1 according to a first embodiment of the invention. The system illustrated in FIG. 1 has a C/S (Client/Server) architecture. The main components of the discovery system 1 are a user client 2, and server apparatus 3. In practice, server apparatus 3 typically serves a plurality of user clients 2 provided in respective user devices. The discovery system 1 provides the user with awareness of the surrounding IoT environment, and may provide the user with access to a desired IoT resource (IoT object or object service), by analyzing user requirements that have been articulated (in some form) by the user and/or that have been inferred or deduced by analyzing the user context.

The user client 2 is implemented in a user device, for example in a mobile phone, tablet, personal computer, and so on. The user client 2 is often provided in the form of a computer program that contains instructions which, when executed by one or more processors of the user device, cause the user device to perform the functions described below as belonging to the user client and cause the user device to embody the functional units described below as belonging to the user client 2. However, the user client may be implemented using general or dedicated hardware components, optionally associated with software. The user client 2 may cooperate with other functional units provided in the user device including, but not limited to, storage units, communication interfaces, and units of the user device which generate data characterizing the user context (e.g. ambient temperature, humidity or other aspects of the user's environment, the user's location, and so on).

In FIG. 1 the server apparatus 3 is illustrated as a monolithic block. However, it will be understood that, in practice, server apparatus 3 may be implemented using various different configurations of software and physical hardware. Thus, for example, the functions and units described below as belonging to server apparatus 3 may be provided using a single server device, by a group of servers cooperating with one another, by one or plural server apparatuses cooperating with external components, and so on, in each case with its/their associated software. Cloud infrastructure may be used to implement the server apparatus 3.

Server apparatus 3 is configured to interrogate one or more IoT-object platforms to detect wanted IoT objects. In addition, server apparatus 3 may be configured to interact with the one or more IoT-object platforms to enable detected IoT objects to be accessed. Server apparatus 3 may be configured to interrogate one or more IoT-object platforms, which may be the same as or different from the platform(s) interrogated to detect wanted IoT objects, to retrieve user-context data generated by IoT devices. Typically, the discovery system 1 is separate from, but interacts with, such IoT-object platforms but, if desired, an integrated system may be constructed which includes the discovery system 2, 3 and one or more IoT-object platforms. FIG. 1 illustrates an example in which server apparatus 3 interacts with a single IoT-object platform 4 which is external to the discovery system 1.

The user client 2 may comprise a user input interface 22 to receive user input indicative of a user requirement and a transmission unit 24 to output information representative of the user input. The user client 2 comprises a reception unit 26 to receive information identifying IoT resources adapted to satisfy user requirements. The user client may further include a client-side user-context identification unit 27, and/or a communications unit 28 configured to communicate with IoT objects in the vicinity of the user device. Some or all of the units 22-28 may be implemented using a common component: for example, a single unit may perform the transmission, reception and communication functions of units 24, 26 and 28.

Typically, the user input interface 22 makes use of user-operated components provided on the user device, e.g. buttons, keys, touch-screen, and so on, via which the user can input a requirement or request. The user client 2 may display a graphical user interface (not shown) to enable (or prompt) the user to input a request or requirement that can be fulfilled using IoT resources.

Typically, the transmission unit 24 and reception unit 26 of the user client 2 make use of communications interfaces and components of the user device to send information to, and receive information from, server apparatus 3 and connected IoT objects.

The server apparatus 3 may comprise an input interface 32 to receive information from the user client 2, notably information representative of user input to the user client 2. The server apparatus 3 comprises a user-context determination unit 34 to determine the user context, a user-requirement assessment unit 35 to determine a user requirement specification, a category identification unit 36 to identify one or more categories of IoT object that match the user requirement specification, an IoT-object-platform interface 37 to interrogate the IoT-object platform 4, to identify IoT resource(s) that correspond to the identified one or more categories of IoT object, and an output unit 38 to send, to the user client, information identifying the IoT resource(s) identified by the IoT-object-platform interface 37.

Some or all of the units 32-38 may be implemented using common components: for example, a single unit may perform the input and transmission functions of units 32 and 38.

The user-context determination unit 34 may be designed to obtain information, regarding aspects of the user context, from different sources. Thus, for example, user-context data may be obtained from the user client 2, from IoT objects, from the IoT-object platform 4, from external (third party) sources, and so on. The user client 2 may provide server apparatus 3 with additional context data, for example a user profile, environmental information obtained by sensors in the user device, and so on. For this purpose, the user client 2 may comprise a client-side user-context identification unit 27 to output, to the server apparatus 3, information indicative of at least one aspect of the user context.

The user client 2 may further include the above-mentioned communications unit 28 and may use the communications unit 28 to interrogate IoT devices local to the user device. This interrogation may serve, for example, to locate IoT devices capable of providing information regarding the user's current context (e.g. the environment in which the user device is currently located). The user client 2 may simply determine which IoT devices are potential sources of context information, and notify the server apparatus 3 of the identity of the relevant potential sources, or the user client may be configured to itself obtain context data from the relevant IoT devices and then to forward the acquired context information to the server apparatus 3.

The user-context determination unit 34 may be configured to acquire user-context data from potential sources identified by the user client 2. Typically, the user-context determination unit 34 may be configured to interrogate an IoT-object platform to retrieve information, indicative of at least one aspect of the user context, generated by the potential sources which have been notified to it by the user client 2.

The user-context determination unit 34 may be configured to acquire data indicative of the user device's current location, for example GPS data generated by a GPS sensor in the user device and transmitted to the server apparatus 3. The user-context determination unit 34 may be configured to contact sources of information to find about the context applicable at this location, e.g. sources of (current, forecast and/or historic) environmental data, sources of directory information regarding devices, businesses, service-providers, points of interest and so on at or near the location. These sources may be external third-party resources (contactable by any convenient means, e.g. over a communications network), or IoT objects (contactable either directly by the server apparatus 3 or via an IoT-object platform).

The user-context determination unit 34 may combine data obtained from any desired combination of sources to generate a definition of the “current” user context, or the user context at some target time. Among others, these sources may be a user profile stored in a database of the network (possibly storing information about user's habits) or information from a social network (for instance hot trends from twitter).

The user-requirement assessment unit 35 functions to produce a user-requirement specification, based on the user-context determined by the user-context determination unit 34. Further, if the user client 2 has provided information from which a user requirement can be determined, the user-requirement assessment unit 35 may take this information into account when producing the user-requirement specification. The invention is not particularly limited having regard to the parameters included in the user-requirement specification nor having regard to the manner in which the specification is expressed. Some examples are described below but it is to be understood that variants can be designed in accordance with the technologies used to implement the category identification unit 36.

The user-requirement assessment unit 35 may comprise a natural-language analysis tool to determine user requirements by processing user input, thus enabling the user to express their wishes using natural language. The user-requirement assessment unit 35 may be implemented using various technologies, as described below, including, but not limited to a natural language processing tool, performing text recognition or semantic entity analysis for instance.

The category identification unit 36 compares the user requirement specification produced by the user-requirement assessment unit 35 with IoT object categories so as to identify categories of IoT objects/resources which meet the user's requirements. The category identification unit 36 may be implemented using various technologies, as described below, including, but not limited to a cognitive reasoning engine and a collaborative filtering unit.

The IoT-object-platform interface 37 is designed to interrogate the IoT-object platform 4, requesting the IoT-object platform 4 to provide details of IoT resources known to the platform which fall into the categories identified by the category identification unit 36. The IoT-object-platform interface 37 may comprise a semantic matching unit (not shown) to determine semantically matched IoT object categories in the IoT-object platform 4 for given object categories of the category identification unit 36. The request sent to the IoT-object platform can thus evoke categories that are known to the platform. As stated earlier, there may be plural IoT-object platforms and the server apparatus 3 may be configured to interrogate all or a desired selection of the IoT-object platforms in order to discover IoT resources to notify to the user.

The output unit 38 operates to send, to the user client 2, information regarding the IoT resources located by the server apparatus 3 as a result of its interrogation of the IoT-object platform. The server apparatus 3 may be configured so that it does more than simply notify the user client of all the results returned by the IoT-object platform 4. Thus, for example, the output unit 38 may restrict the results returned to the user client 2 to those which are effectively usable by the user.

For example, if some IoT resources which otherwise match the user's requirements are only usable by authorized people, then a check may be made as to whether or not the user is authorized to use the resource and, if not, the IoT resource in question may be omitted from the results returned to the user client 2.

As another example, the server apparatus 3 and/or IoT-object platform 4 may be configured to generate information (operating instructions, access codes, communication frequencies, encryption keys, and so on) which is necessary or helpful in order for the user to be able to access a given IoT resource.

FIG. 2 illustrates the architecture of a discovery system 100 which is one example of a specific embodiment of the system according to FIG. 1. According to this example the server apparatus is implemented using cloud infrastructure and is called a “discovery cloud”.

In the system 100 according to the example of FIG. 2, the user client 200 is responsible for scanning the nearby connectable IoT devices, collecting user input and context, getting IoT resource data from the discovery cloud and helping the user to access the identified IoT objects. The main functional modules are:

210 Object Scanner—Utilizes the client device's radio connection, including WIFI, Bluetooth, GPS and etc., to scan nearby connectable devices to get possible contextual data around the user: for instance, like user's current location via GPS, open data of nearby temperature or humidity monitoring devices directly retrieved by WIFI or Bluetooth connection.

220 User Inputter—With user authorization, the user inputter 220 collects user input and user context from the client side, which will be sent to the discovery cloud so that suggestions of suitable IoT objects can be obtained. Wherein:
The user inputs their requirement(s) by text or voice. For instance: “I want to have dinner at place A tomorrow at noon”. If the user input is voice, this will first be converted to text by a STT (Speech-To-Text) converter (not shown).
User context can come from several sources, including data from the object scanner 210, for example: user's current location via GPS, temperature data from a nearby shared thermometer, or even personal data, like the occupation, age, gender, etc. The collection of this data can be made subject to user authorization. The collected data is then sent to the discovery could for analysis

230: Object Interactor—Based on the knowledge retrieved from the IoT Object Platform by the discovery cloud, the object interactor retrieves IoT objects' information, presents it to the user and helps the user to connect to IoT objects' services.

The discovery cloud 300 comprises a knowledge extractor 310 to analyze user's requirements as expressed in input that may be received from the user client, and a context collector 320 to establish and replenish user context data. The data provided by the knowledge extractor 310 and context collector 320 defines a requirement specification. The discovery cloud further comprises a categorizer 330 which, based on the requirement specification, deduces what kinds of IoT objects may interest the user, and an IoT-object platform adapter 340 to query the IoT-object platform to find out corresponding objects and return them back to the user client.

These different modules of the discovery cloud 300 are as follows:

310 Knowledge Extractor—From user's input (texts, or texts converted from voice) sent by the user client, analyzes user's requirement to obtain:
User intention: for instance, the intention “printing” may be determined for input “I want to print my photo”, the intention “eating” may be determined for input “I am hungry”, the intention “cooling” may be determined for input “it is too hot”, etc.
Target entities, including target location, target time, target person, etc. For example, in a case where the user input is “I want to have a dinner at place A tomorrow noon”, then the knowledge extractor may determine that the intention is “eating”, the target location is “place A”, and the target time is “tomorrow noon”

The knowledge extractor 310 may make use of a natural language processing tool 315, such as IBM's waston, Google's AI.API etc.

320 Context Collector—Replenishes user context from multiple sources, including:
Authorized user data from the user client, including user location, user profile (optional, such as occupation, age, gender, etc.)
Environment data: such as weather, temperature, humidity, air quality, etc., which may be:
   data of shared nearby devices found and retrieved directly by the user client
   data of shared nearby devices found by the user client, but data is retrieved from IoT object platform
   data from 3^{rd} party information sources 325, for instance Yahoo weather service, etc., according to user context and/or requirements (e.g. user's current location, a target location, etc.),

330 Categorizer—According to analysis of user-expressed requirements, collected user contexts, etc. the categorizer 330 deduces what kinds of IoT objects may interest the user (notably may meet the user requirements). For example, the categorizer may establish a list of object categories corresponding to the types of object adapted to satisfy the user's requirements. The categorizer 330 may comprise, or communicate with, a cognitive reasoning engine 335.

The cognitive reasoning engine 335 may be implemented in various forms including, but not limited to, the following options:
a rule-based reasoning engine, using preset rules to deduce the category list. Typically, the rules applied by the rule-based reasoning engine are manually created. Table 1 below provides two examples of such rules.

TABLE 1

| Rule name | Condition | Categories of Object |
|---|---|---|
| “too hot” | context: temperature > 30 | [air conditioner, cool water |
| | degrees | machine] |
| “print” | intention = printing | [printer, printing shop] |

a knowledge-graph-based reasoning engine, using a knowledge graph to deduce categories from information gathered from a variety of sources. Knowledge graphs are known; for example, they are described in Wikipedia (see https://en.wikipedia.org/wiki/Knowledge_Graph), and in the blog post entitled “Introducing the Knowledge Graph: Things, Not Strings” by Singhal, Amit (May 16, 2012, Google Official Blog), and so no additional details are provided here.

FIG. 3 illustrates schematically an example of a knowledge graph for use in identifying IoT object categories based on a given user context and user intention. In this example the knowledge graph encodes knowledge regarding a room (a pantry) in a building A, as well as knowledge of the objects and devices in this pantry.

Other widely-used methodologies may be exploited by the categorizer 330, including:
Personalized selection—select IoT object categories according to a user profile (if it is authorized), for example: select a connected coffee machine for white-collar staff if the time is 10:30 am or 13:00 pm, based on knowledge of the user's prior behavior; and
Collaborative Filtering—collaborative filtering encompasses techniques for matching people with similar interests and selecting object categories on this basis, for example: at place A select the devices most-accessed by people at place A; if the user has accessed device B, select the most popular devices that users access if they have accessed device B.

340 IoT-object platform adapter—The device categories in the result produced by the categorizer 330 may not conform to those category definitions which are used in the IoT-object platform 400. If the IoT-object platform 400 does not support semantic searching for IoT objects, the IoT-object platform adapter 340 may provide a mechanism as a module to match two different sets of device category definitions, so the discovery cloud 300 can query corresponding devices from the IoT-object platform 400.

A simple way to realize the IoT-object platform adapter 340 is to build a map between two different sets of device category definitions. This needs to be done case by case, e.g. build different mappings for different IoT-object platforms.

A semantic matching engine 345, using vector representation for word/document methods, may be employed by the IoT-object platform adapter 340. Examples of suitable methods include, but are not limited to:
Word2Vec (described in the following papers: “Efficient Estimation of Word Representations in Vector Space” by Tomas Mikolov, Kai Chen, Greg Corrado, and Jeffrey Dean, in Proceedings of Workshop at ICLR, 2013; and “Distributed Representations of Words and Phrases and their Compositionality.” by Tomas Mikolov, Ilya Sutskever, Kai Chen, Greg Corrado, and Jeffrey Dean in Proceedings of NIPS, 2013);
Doc2Vec (described in Distributed Representations of Sentences and Documents” by Quoc Le and Tomas Mikolov);
fastText (described at https://research.fb.com/fasttext); and
GloVe (described at https://nlp.stanford.edu/projects.glove in “Global Vectors for Word Representation” by Jeffrey Pennington, Richard Socher, and Christopher D. Manning)

The IoT-object platform adapter 340 may adopt such methods to find semantically matched device categories in the IoT-object platform 400 for a given device category provided by the categorizer 330, via comparing the semantic similarities between two category names or descriptions (if the IoT-object platform provides category description):
Word Similarity: similarity of category's name phases using word's vector representations, like Word2Vec, fastText, etc.
For example, for category A and category B, the word similarity is given by the following expression:

word_similarity(A,B)=cosine_similarity (vector(A's name phase), vector(B's name phase))
Document Similarity: similarity of category's description using sentence vector representations, like Doc2Vec, fastText, etc. For example, for category A and Category B, the document similarity is given by the following expression:

doc_similarity(A,B)=cosine_similarity(vector(A's description sentences), vector(B's description sentences))

The cosine similarity metric is well-known and is, for example, described at https://en.wikipedia.org/wiki/Cosine_similarity; accordingly no further details are provided here.

400—IoT Object Platform. The IoT-object platform 400 provides direct access to IoT object data and services, or knowledge to access IoT object data and services. Examples of IoT object platforms with which the invention may be used include, but are not limited to, Thing'in provided by Orange, DataVenue provided by Orange, and other 3^{rd} party platforms.

FIG. 4 is a flow diagram illustrating steps in a discovery method according to the invention, which may be implemented by a discovery system comprising a user client and server apparatus.

In the method of FIG. 4, user input to a user client implemented on a user device is monitored (S401), and the user input may be indicative of a user requirement. Optionally, the user client may determine an information item representative of the user context. Responsive to the monitoring (and determining of context, if performed), information representative of the user input (and user context) is output to the server apparatus (S402). The server apparatus: receives the information representative of user input (and user context information, if any is transmitted) from the user client (S403), determines the user context (S404), and determines a user requirement specification based on the determined user context and, in the case where information representative of user input has been received from the user client, additionally based on this received information (S405). The server apparatus identifies one or more categories of IoT object that match the user requirement specification (S406), interrogates an IoT-object platform to identify IoT resource(s) that correspond to the identified one or more categories of IoT object (S407), and sends, to the user client, information identifying the IoT resource(s) detected by the interrogating of the IoT-object-platform (S408).

In the method of FIG. 4, the server apparatus may make a determination as to which of the IoT resources identified by interrogating the IoT-object platform are effectively available to the user (e.g. excluding resources which are offline, powered-down, malfunctioning and/or not authorized for use by the user). In such a case, in step S408 the server apparatus may only send the user client details of the effectively available IoT resources (to save communications bandwidth).

FIG. 5 illustrates a typical workflow in an example embodiment of the above-described system and method.

Step S501. The whole procedure may be triggered by various events/actions including, but not limited to: user input of their requirement to find something on the user client, a successful data retrieval of a specific IoT object (e.g. a shared electric thermometer) during a regular scan of nearby IoT objects by the user client, an IoT-resource discovery request by the user client under some preset rule (e.g. a rule “request every half hour”), etc.

Step S502. The user client sends information regarding the user requirement in text form (if user input is via voice, this is first be converted to text), and sends user context (including retrieved nearby object data, user current location, authorized user personal data) to the server apparatus, so as to obtain information regarding IoT resources.

Step S503. After receipt of the user request and data from the user client, the server apparatus analyzes the user intention and target entities from the user input (if there are user inputs), and replenishes user contexts by retrieving, from the IoT object platform, possible open data of objects near the user, or environment data from the open 3^{rd} party sources.

Step S504. According to the user intention and target entities (if there are some), and user contexts obtained by Step S503, the server apparatus deduces object categories which may satisfy the user's requirements, by a methodology which may include cognitive reasoning, etc. as noted above.

Step S505. The server apparatus queries the IoT-object platform (with or without an IoT-object-platform adapter) to find matched IoT objects, according to the deduced object categories obtained by Step S504, and some complementary conditions (which could, for example, be the user's target location and time (if these exist), or it could just be user current location).

Step S506. The server apparatus returns information identifying the matched IoT objects to the user client.

Step S507. On the user client, the user accesses recommended IoT objects, or interacts with these objects via the IoT-object platform

Some example applications of embodiments of the invention will now be described.

### Example Application 1—Requirement Specification not Based on Explicit User Input

### Use Case: Proposal of a Cold Beverage or Other Cooling Resource

1. On a hot summer day, a user is passing by a place where there is a shared air/temperature monitoring device.
2. The authorized client app (user client) on a terminal carried by the user detects this shared air/temperature monitoring device, and retrieves data regarding the status of the environment surrounding the user from this air/temperature monitoring device by direct WIFI or Bluetooth connection.
3. The client app then sends the user's context (environment status and current position) to server apparatus in the cloud.
4. The cloud service analyzes the user's context, determines that the user may need some cold beverage or water for cooling, and after querying the IoT-object platform, informs the user of some IoT objects which may provide refreshment under the user's agreement, including:
a beverage machine (selling cold or iced drink) nearby
a water dispenser nearby
a swimming pool not far away.
   5. Based on the IoT-resource information provided by the cloud, the user may find the beverage machine, and employ the user client to access a service of the beverage machine (here, which may be the menu), and finally buys a cold beverage.

### Example Application 2—Requirement Specification Based on Explicit User Input and Requirements Inferred, by the Cloud Architecture, Based on Context

Use Case: “I want to Print My Picture”
1. A user wants to print some of their own pictures, and so opens the client app (user client) on their user device and inputs their requirement e.g. by typing in a message “I want to print my picture” on a keyboard.
2. The client app sends the user's request and current position to the server apparatus.
3. The server apparatus analyzes the user's input, determines that the user may need some printing service and, after querying the IoT-object platform, informs the user of some IoT objects that the user may select:
a connected and shared printer nearby
a printing shop (not connectable) nearby
   4. The user chooses the shared printer in view of the close proximity of the printer and the cheap cost, having been informed by the server apparatus of the location and cost associated with each of the IoT objects.
   5. Finally, the user finds the printer and pays for printing from the client app.

FIG. 6 is a flow diagram illustrating steps in an example of a computer-implemented method according to an embodiment of the invention, implemented by server apparatus.

In the method of FIG. 6, the server apparatus receives, from a user client, information representative of user input, and this information is indicative of a user requirement (S601). It should be noted that this step is optional, and the method may determine a user-requirement specification without explicit user input of a requirement. The server apparatus determines the user context (S602). The server apparatus determines a user requirement specification, based on the determined user context and, in the case where information representative of user input has been received from the user client, additionally based on such received information (S603). The server apparatus identifies one or more categories of IoT object that match the user requirement specification (S604). The server apparatus interrogates an IoT-object platform to identify IoT resource(s) that correspond to the identified one or more categories of IoT object (S605). The server apparatus sends, to the user client, information identifying the IoT resource(s) detected by the interrogating of the IoT-object-platform (S606).

FIG. 7 is a flow diagram illustrating steps in an example of a computer-implemented method according to an embodiment of the invention, implemented by a user client in a user device.

In the method of FIG. 7, the user client on the user device monitors an input interface of the user client for user input indicative of a user requirement (S701). The user client interrogates IoT devices local to the user device to determine at least one item of information descriptive of the user context (S702). The user client outputs, to server apparatus, information representative of received user input indicative of a user requirement and information, received from interrogated IoT devices, indicative of the user context (S703). The user client receives, from the server apparatus, information identifying one or more IoT resources available to the user device and having properties adapted to satisfy a user requirement determined from the user context and, if provided, also from user input (S704).

Although the invention has been described above with reference to certain specific embodiments, it is to be understood that various modifications and adaptations may be made within the scope of the appended claims.

1. A discovery system to discover Internet of Things (IoT) resources for a user, the system comprising:
a user client implemented in a user device, the user client comprising a reception unit to receive information identifying IoT resources adapted to satisfy user requirements; and
the server apparatus of claim 11
wherein the output unit is configured to send, to the user client, the information identifying the at least one IoT resource identified by the IoT-object-platform interface.

2. The discovery system of claim 1, wherein:
the user client further comprises:
a user input interface to receive user input indicative of a user requirement, and
a transmission unit to output information representative of the user input to the server apparatus; and
the server apparatus further comprises an input interface to receive, from the user client, the information representative of the user input; and
the user-requirement assessment unit of the server apparatus is configured to determine the user requirement specification based on the user context determined by the user-context determination unit and on information, received from the user client, representative of the user input.

3. The discovery system of claim 1, wherein:
the user client further comprises a client-side user-context identification unit to output, to the server apparatus, information indicative of at least one aspect of the user context; and
the user-context determination unit of the server apparatus is configured to determine the user context taking into account user-context information received from the user client.

4. The discovery system of claim 1, wherein the user client further comprises a communications unit (28) to interrogate IoT devices local to the user device.

5. The discovery system of claim 4, wherein the communications unit is configured to obtain information indicative of at least one aspect of the user context by interrogating IoT devices local to the user device, and the user client comprises a client-side user-context identification unit to output, to the server apparatus, context information obtained from the interrogated IoT devices.

6. The discovery system of claim 4, wherein the user client is configured to notify the server apparatus of IoT devices interrogated by the communications unit, and the user-context determination unit is configured to interrogate an IoT-object platform to retrieve information, indicative of at least one aspect of the user context, generated by the IoT devices identified in the notification.

7. The discovery system of claim 1, wherein the user-requirement assessment unit comprises a natural-language processing tool to determine user requirements by processing user input expressed in natural language.

8. The discovery system of claim 1, wherein the category identification unit comprises at least one of:
a cognitive reasoning engine, and
a collaborative filtering unit.

9. The discovery system of claim 1, wherein the IoT-object-platform interface is configured to interrogate the IoT-object platform using adapted object categories mapped from the object categories identified by the category identification unit by a semantic matching unit, the semantic matching unit being configured to determine semantically matched IoT object categories in the IoT-object platform for the object categories of the category identification unit.

10. The discovery system of claim 1, wherein the output unit is further configured to:
inform the user client only of IoT resources that are available to the user, and
send, to the user client, access information indicative of how to access the identified IoT resources.

11. A server apparatus comprising:
a user-context determination unit to determine a user context,
a user-requirement assessment unit to determine a user requirement specification based on the user context determined by the user-context determination unit,
a category identification unit to identify at least one category of IoT object that matches the user requirement specification,
an IoT-object-platform interface to interrogate an IoT-object platform, to identify at least one IoT resource that corresponds to the identified at least one category of IoT object, and
an output unit to send, to a user client implemented on a user device, information identifying the at least one IoT resource identified by the IoT-object-platform interface.

12. A user device in which is implemented a user client comprising:
a user input interface configured to receive user input indicative of a user requirement;
a transmission unit configured to output, to a server apparatus, information indicative of received user input indicative of a user requirement;
a reception unit configured to receive, from the server apparatus, information identifying at least one IoT resource available to the user device and having properties adapted to satisfy the user requirement, determined from the user context and, if provided, also from user input.

13. A computer-implemented method performed by a server apparatus, the method comprising:
determining a user context,
determining a user requirement specification based on the determined user context, and
identifying at least one category of IoT object that matches the user requirement specification,
interrogating an IoT-object platform to identify at least one IoT resource that corresponds to the identified at least one category of IoT object, and
sending, to a user client implemented on a user device, information identifying the at least one IoT resource identified by the interrogating of the IoT-object-platform.

14. A computer comprising a processor and a memory, the memory having stored thereon a instructions which, when executed by the processor, cause the user device to implement the method of claim 15.

15. A computer-implemented method, performed by a user client on a user device, comprising:
monitoring an input interface of the user client for user input indicative of a user requirement;
outputting, to server apparatus, information representative of received user input indicative of a user requirement; and
receiving, from the server apparatus, information identifying at least one IoT resource available to the user device and having properties adapted to satisfy a user requirement determined from the user context and, if provided, also from user input.
